(19) United States
(12) Patent Application Publication
(10) Pub. No.: US 2006/0037550 A1
(43) Pub. Date: Feb. 23, 2006

(54) Apparatus and method of harvesting shellfish

(76) Inventors: Roy C. May, Beaufort, SC (US); C. Roland Moore, Beaufort, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/046,220

(22) Filed: Jan. 28, 2005

Related U.S. Application Data
(60) Provisional application No. 60/540,436, filed on Jan. 30, 2004.

(51) Int. Cl. A01K 61/00

(52) U.S. Cl. 119/234

(57) ABSTRACT

A shellfish harvesting apparatus and a method of using the apparatus to harvest shellfish is provided. A floating vessel and harvester are provided to harvest shellfish from the waters surrounding the vessel. A turret, an elongated boom attached to the turret, a gathering arm attached to boom, and a gathering device attached to the gathering arm make up the mechanical structure of the harvester. Using this apparatus to harvest shellfish thereby is accomplished in an efficient manner while reducing disruption to the ecosystem.

### BACKGROUND OF THE INVENTION

The present invention relates generally to the harvesting of shellfish, and more particularly to an improved apparatus and method of harvesting shellfish.

Many varieties of shellfish live in or near the coastal waters of the world. Harvesting some of these shellfish for human consumption has occurred for centuries. In the coastal waters of South Carolina, in particular, oysters, a type of shellfish, live in beds forming small rolling hills beneath shallow coastal waterways. Historically, the oysters in these beds were manually picked from the beds using hand tools by workers standing in the shallow waters near the beds. In deeper waters, as are common in the waters around the Gulf of Mexico, dredging by pulling a dredge behind a boat is a common way to harvest oysters. Yet another way to harvest oysters is to vacuum the oysters from their beds into a boat using a suction pump.

Other than manual harvesting of oysters, which is prohibitively slow, the other known methods of harvesting oysters suffer the problem of severely disturbing or destroying the oyster beds. Such destruction of the oyster beds limits the ability of the oyster beds to regenerate themselves, thus reducing the number of oysters available for harvesting in the future.

For the foregoing reasons, there is a need for a shellfish harvesting apparatus and method which harvests a large number of oysters in a small amount of time, without unduly destroying the oyster beds.

### SUMMARY

The present invention recognizes and addresses considerations of prior art constructions and methods and provides a shellfish harvesting apparatus for quickly harvesting oysters reducing destruction of the oyster beds.

The present invention is directed to a shellfish harvesting apparatus comprised of a floating vessel and a harvester on the floating vessel. An elongated boom with first and second ends is attached to the floating vessel at its first end. Optionally, a turret is placed between the floating vessel and the boom. A gathering arm having first and second ends is attached to the boom at a location proximate the gathering arm's first end and the boom's second end. A gathering device is attached proximate the gathering arm's second end. The entire harvester is configured to harvest shellfish from the waters surrounding the floating vessel.

In one embodiment, the gathering device and the floating vessel are equipped to spray fluid onto shellfish within the gathering device. To accomplish this, rinsing ports may be attached to the side of the floating vessel and spray ports may be located adjacent the gathering device. To utilize the rinsing ports, the gathering device is brought in line with the rinsing ports by the harvester's mechanical linkage.

The accompanying drawings, incorporated in and constituting part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a side view of a oyster harvesting system constructed according to an embodiment of the present invention with the boom positioned over the boat;

FIG. 2 is side view of the oyster harvesting system of FIG. 1 with the boom extending over the bow of the boat;

FIG. 3 is an exploded view of a gathering device constructed according to an embodiment of the present invention;

FIG. 4a is a side view of the gathering device of FIG. 3 assembled but in an open position;

FIG. 4b is a side view of the gathering device of FIG. 3 assembled but in a closed position;

FIG. 5 is a top diagrammatical view of the harvesting system;

FIG. 6a is a side view of the gathering device holding a plug, prior to rinsing;

FIG. 6b is a side view of the gathering device of FIG. 6a, in which the plug is being rinsed; and

FIG. 6c is a front view of the oyster harvesting system in which the gathering device is being rinsed by the side rinsing ports.

Repeat use of reference characters in the present specification and drawings is intended to represent same or analogous features or elements of the invention.

### DETAILED DESCRIPTION OF EXEMPLARY EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

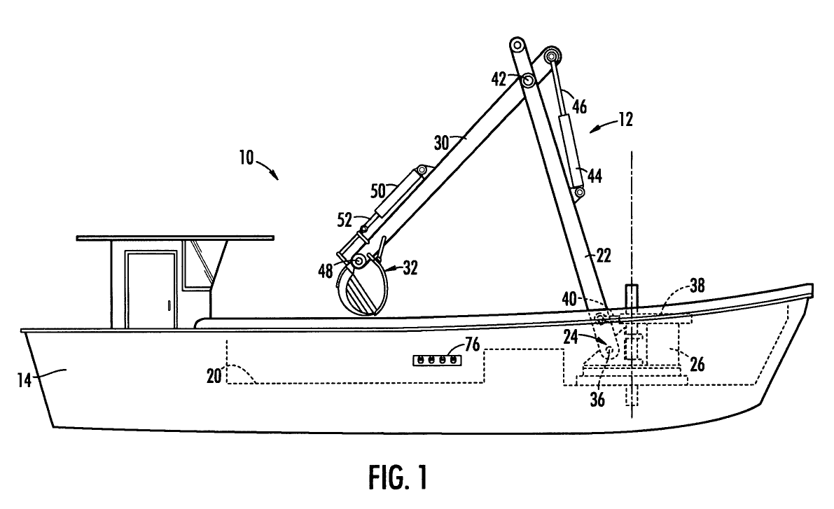

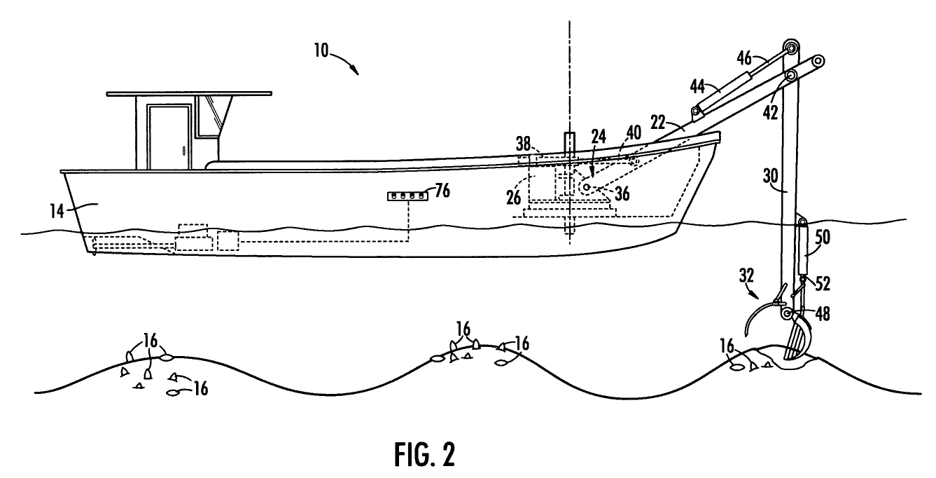

Referring to FIGS. 1 and 2, the present invention provides an apparatus, generally referred to by reference number 10, for harvesting shellfish which reduces disruption of the beds in which remaining shellfish continue to grow. Although apparatus 10 will be described below with respect to oyster harvesting, it should be appreciated that apparatus 10 could also be used to harvest other types of shellfish, such as clams and mussels.

Apparatus 10 has a harvester 12 for gathering oysters 16 from the oyster beds and placing them on a deck 20 of a boat 14. As described in more detail below, apparatus 10 contains means for rinsing oysters 16 gathered by harvester 12 before oysters 16 are placed in boat 14. By rinsing oysters 16 prior to placement in boat 14, mud (and other debris) will remain in the beds, thereby reducing any negative impact to the environment and also promoting the growth of oysters remaining in the beds.

Harvester 12 includes a boom 22 with a first end 24 pivotally attached to a turret 26. Turret 26 rotates about a vertical axis, which in turn rotates boom 22 about a vertical axis. The vertical axis is the axis perpendicular to the water beneath the boat. For example, boom 22 is positioned over the deck 20 of the boat 14 in FIG. 1, but is rotated to a position extending beyond the front of the boat 14 in FIG. 2. In one embodiment, turret 26 can rotate three-hundred and sixty degrees (360°) so that boom 22 can pivot to the front and sides of the boat 14. One skilled in the art should recognize that turret 26 could be rotated by any suitable rotary device, such as using a motor. The location of turret 26 on the boat is not critical. In the Figures, turret 26 is shown in the bow of the boat. Turret 26 could also be located near the stern of the boat or, preferably, proximate the center of the boat.

Boom 22 is also capable of rotating about pivot point 36. In the embodiment shown, a hydraulic cylinder 38 is provided with a piston 40 connected to boom 22. As piston 40 extends out of cylinder 38, boom 22 rotates downward (counterclockwise in FIG. 1) about pivot point 36. Retraction of piston 40 into cylinder 38, however, pivots boom 22 upward (clockwise in FIG. 1). It should be appreciated that the length of boom 22 will vary depending upon the extent to which boom 22 is desired to extend beyond deck 20 of boat 14.

Boom 22 is pivotally connected to a gathering arm 30 about pivot point 42. A hydraulic cylinder 44 mounted on boom 22 is provided with a piston 46 connected to gathering arm 30. Gathering arm 30 rotates downward (counterclockwise in FIG. 1) as piston 46 extends out of cylinder 44. As piston 46 retracts into cylinder 44, gathering arm 30 rotates upward (clockwise in FIG. 1) about pivot point 42. As with the length of boom 22, the length of gathering arm 30 will vary depending upon the desired reach beyond deck 20 of boat 14.

A gathering device 32 is pivotally connected on the distal end of gathering arm 30 and rotates about pivot point 48. A hydraulic cylinder 50 mounted to gathering arm 30 is provided with a piston 52 connected to gathering device 32. Gathering device 32 opens and closes with the extension and retraction of piston 52, as discussed in more detail below. It should be appreciated that hydraulic lines (not shown) would be provided to supply hydraulic fluid to each hydraulic cylinder 38, 44 and 55. Moreover, one skilled in the art would recognize other suitable linear drivers could be provided in place of hydraulic cylinders.

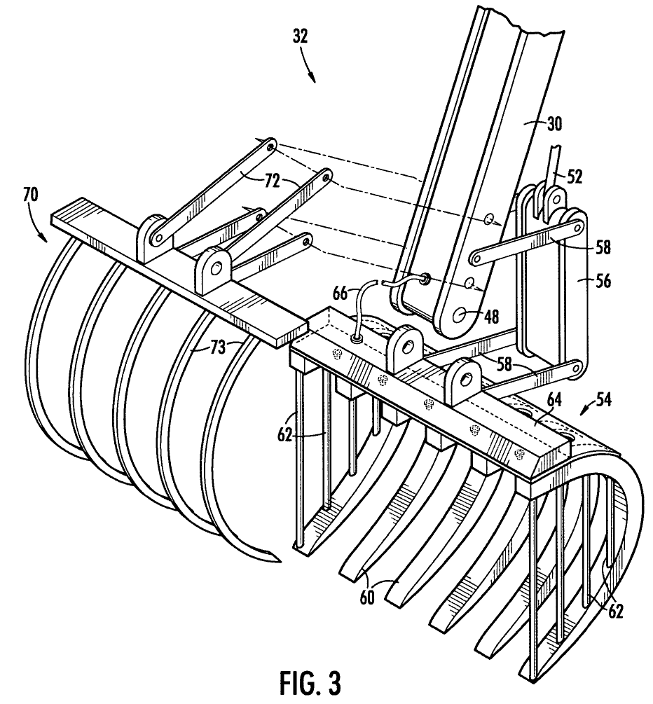

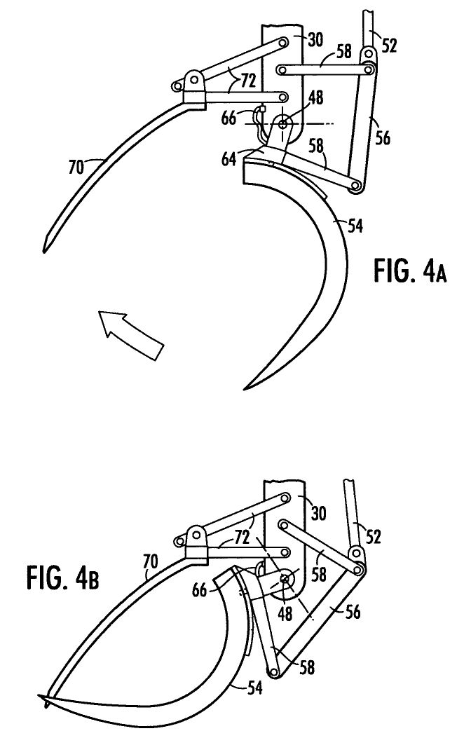

Referring to FIG. 3, there is shown an exploded view of gathering device 32. Gathering device 32 has a rake 54 that pivots about pivot point 48 on the distal end of gathering arm 30. A pivot member 56 hinges rake 54 to gathering arm 30 using brackets 58. As best seen in FIGS. 4a-4b, movement of piston 52 pivots rake 54 between an open position (FIG. 4a) and closed position (FIG. 4b).

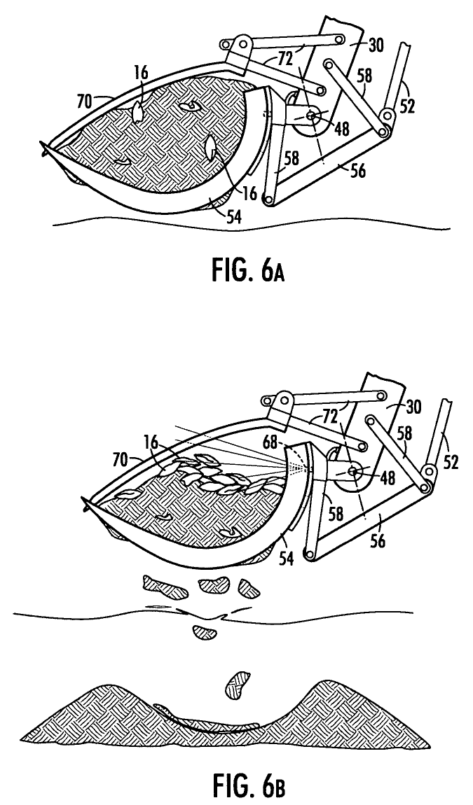

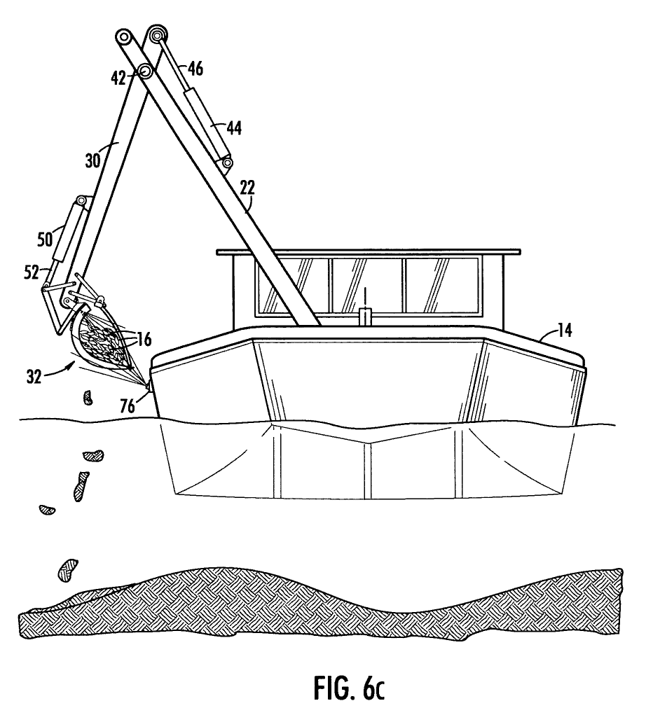

Rake 54 has a plurality of spaced-apart prongs 60 to entrap oysters 16 while permitting smaller objects, such as mud and other debris, to pass therethrough. See FIGS. 6a-6c. It should be appreciated to one of ordinary skill of the art that the spacing between prongs 60 may differ depending upon the size of oysters being harvested. Preferably, the spacing between prongs 60 is slightly less than size of the oysters (or other shellfish) being harvested. In the embodiment shown, prongs 60 are arcuate in shape and tapered to allow easy insertion into a bed of oysters. Each side of rake 54 has side bars 62 which are spaced apart a sufficient distance to entrap the oysters (or other shellfish) being harvested, but allow other debris to pass therethrough.

Rake 54 also contains a spray bar 64 with a plurality of spray ports 68. Spray ports 68 are in fluid communication, preferably in a manifold manner, with a rinse inlet 66, which provides access to a supply of fluid to rinse oysters of debris. As discussed in more detail below, the user can activate spray ports 68 to rinse oysters 16 prior to placing the oysters 16 on deck 20 of boat 14.

Gathering device 32 also contains a gathering support 70 which is attached to gathering arm 30 using support braces 72. In the embodiment shown, support braces 72 fix the position of gathering support 70; however it should be appreciated that gathering support 70 could be pivoted in a similar manner as rake 54. It should also be appreciated that the angle with which rake 54 and gather support 70 are oriented with respect to gathering arm 30, could be altered as desired. Gathering support 70 has a plurality of spaced-apart fingers 73. The spacing of fingers 73 are configured in a matter similar to that of prongs 60 of rake 54, which entraps the oysters being harvested, but allows smaller objects to pass therethrough.

Apparatus 10 includes means for rinsing the oysters 16 to be harvested prior to placing oysters 16 on deck 20 of boat 14. Rake 54 has spray ports 68 which are in fluid communication with rinse inlet 66 to remove debris from the oysters to be harvested. Moreover, each side of the boat has a respective rinsing port 76 and 76′ for spraying the oysters prior to placement on deck 20 of boat 14.

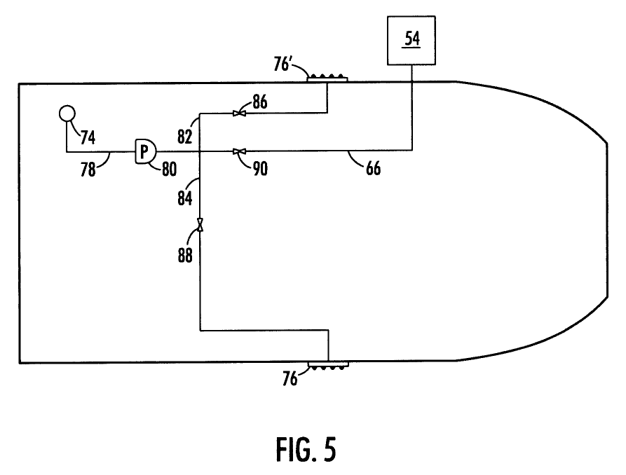

Referring to FIG. 5, there is shown a diagrammatical view of the flow passages including a fluid supply inlet 74 to rake 54 and rinsing ports 76 and 76′. Fluid supply inlet 74 is in fluid communication with a source of fluid, such as water. In one embodiment, the sea water on which the boat is floating provides the fluid supply. A first line 78 provides fluid communication between inlet port 74 and pump 80. A first pump line 82 and second pump line extend from pump 80 to rinsing ports 76 and 76′. A first valve 86 and a second valve 88 are also provided to open and close respective side rinsing ports 76 and 76′, as desired. Rinse inlet 66 provides fluid communication between pump 80 and spray port 68 of rake 54. A third valve 90 is provided to open and close fluid communication through rinse inlet 66. It should be appreciated that valves 86, 88 and 90 could be manually operated or electronic solenoids. In one embodiment, pump 80 is driven by a propulsion engine (not shown) of boat 14 using a belt-drive pump. In this embodiment, a clutch (not shown) would be provided to engage and disengage pump 80 when needed for rinsing.

Referring to FIGS. 6a through 6c, the method for using apparatus 10 should be easily understood. Gathering device 32 is moved into a position to gather the oysters to be harvested by pivoting and rotating boom 22 and gathering arm 30 with rake 54 in its open position. Gathering device 32 is inserted into a bed with oysters 16 and rake 54 is moved to its closed position. Accordingly, a portion of the bed is grasped by gathering device 32. Fluid is then sprayed through spray ports 68 on rake 54 to partially remove debris from oysters 16 and return it back to the bed.

Next, gathering device 32 is moved in alignment with one of the side rinsing ports 76 or 76′, as shown in FIG. 6c. Fluid is then sprayed through rinsing ports 76 or 76′ to further clean the oysters entrapped in gathering device 32, prior to deposit of oysters 16 on deck 20 of boat 14.

Once the oysters are rinsed, boom 22 is moved in a position over deck 20 of boat 14 to deposit oysters 16. Rake 54 is then moved to its open position, thus releasing the oysters from gathering device 32 to deck 20 of boat 14. To aid in the maintenance of the oyster beds, gathering device 32 may then be used to smooth the area of the bed which was removed during harvesting. For example, portions of the beds adjacent to area which was harvested could be raked into the harvested area using gathering device 32.

The harvested oysters may then be transported to a shucking operation for processing. In one embodiment, boat 14 is placed in a trailer (without removal of oysters from deck 20) and directly transported to a shucking operation. After the oysters have been shucked, the shells may be placed in oyster beds, as needed.

Optionally, gathering device 32 could take on various shapes. For example, in addition to the rake and gathering support construction discussed above and shown in the Figures, the gathering device could comprise a single scoop in the position of gathering support 70. Such a single scoop would gather oysters 16 by pulling the scoop toward boat 14 while raising the scoop. The scoop may include holes so that spray ports could wash the oysters before bringing the oysters aboard. The holes in the scoop could be sized such that debris would pass through them while the oysters remain within the scoop. The front edge of the scoop could be designed with ridges for penetrating the oyster beds more easily. Those of skill in the art will appreciate that other features and configurations of the scoop would be possible in conjunction with the present invention.

While one or more preferred embodiments of the invention have been described above, it should be understood that any and all equivalent realizations of the present invention are included within the scope and spirit thereof. The embodiments depicted are presented upon the present invention. Thus, those of ordinary skill in this art should understand that the present invention is not limited to these embodiments since modifications can be made. Therefore, it is contemplated that any and all such embodiments are included in the present invention as may fall within the scope and spirit thereof.

What is claimed:

1. A shellfish harvesting apparatus comprising:
a floating vessel; and
a harvester on the floating vessel, said harvester including:
a turret located on the floating vessel;
an elongated boom having a first end and a second end, the boom's first end being attached to the turret;
a gathering arm having a first end and a second end, the gathering arm being attached to the elongated boom at a location proximate the gathering arm's first end and proximate the boom's second end; and
a gathering device attached proximate the gathering arm's second end;
wherein the harvester is configured to harvest shellfish from the waters surrounding the floating vessel.

2. A shellfish harvesting apparatus as in claim 1 wherein the turret is fixed to the floating vessel.

3. A shellfish harvesting apparatus as in claim 2 wherein the turret is motorized and capable of rotating the harvester relative to the floating vessel about an axis perpendicular to the plane of the water beneath the floating vessel.

4. A shellfish harvesting apparatus as in claim 3 wherein the boom and the turret connect at a first pivot point, the boom and the gathering arm connect at a second pivot point and the gathering arm and the gathering device connect at a third pivot point.

5. A shellfish harvesting apparatus as in claim 4 further comprising a first actuator connected to the turret and the boom, a second actuator connected to the boom and the gathering arm, and a third actuator connected to the gathering arm and the gathering device, the first actuator configured to move the boom relative to the turret about the first pivot point, the second actuator configured to move the gathering arm relative to the boom about the second pivot point, and the third actuator configured to move the gathering device relative to the gathering arm about the third pivot point.

6. A shellfish harvesting apparatus as in claim 5 wherein at least one actuator is a piston and hydraulic cylinder arrangement.

7. A shellfish harvesting apparatus as in claim 1 wherein the floating vessel is a boat.

8. A shellfish harvesting apparatus as in claim 7 wherein the turret is fixed to the boat proximate the center of the boat.

9. A shellfish harvesting apparatus as in claim 7 further comprising rinsing ports attached to the boat, the rinsing ports configured to spray a liquid into the gathering device when the gathering device is located proximate the rinsing ports.

10. A shellfish harvesting apparatus as in claim 1 further comprising spray ports located adjacent the gathering device, the spray ports configured to spray a liquid onto shellfish within the gathering device.

11. A shellfish harvesting apparatus as in claim 10 wherein the gathering device is a scoop, the scoop having voids so that shellfish remain in the scoop while debris may be washed away by the spray ports.

12. A method of harvesting shellfish comprising the steps of:
providing a shellfish harvesting apparatus comprising a floating vessel and a harvester on the floating vessel, the harvester further comprising a turret located on the floating vessel, an elongated boom having a first end and a second end at opposite distal ends of the boom, the boom's first end being attached to the turret, a gathering arm having a first end and a second end at opposite distal ends of the arm, the gathering arm and the elongated boom being attached proximate the gathering arm's first end and proximate the boom's second end, and a gathering device attached proximate the gathering arm's second end, wherein the harvester is configured to harvest shellfish from the waters surrounding the floating vessel; and
harvesting shellfish with said apparatus.

13. The method of claim 12 wherein the harvesting further comprises the steps of:
lowering the gathering device into the waters near the floating vessel;
gathering shellfish in the gathering device;
moving the gathering device into a position above a portion of the floating vessel; and
depositing the shellfish onto a surface of the floating vessel.

14. The method of claim 13 further comprising the step of spraying the shellfish with a liquid while the shellfish are substantially within the gathering device.

15. A shellfish harvesting apparatus comprising:
a floating vessel; and
a harvester on the floating vessel, said harvester including:
an elongated boom having a first end and a second end, the boom's first end being attached to the floating vessel;
a gathering arm having a first end and a second end, the gathering arm being attached to the elongated boom at a location proximate the gathering arm's first end and proximate the boom's second end; and
a gathering device attached proximate the gathering arm's second end;
wherein the harvester is configured to harvest shellfish from the waters surrounding the floating vessel.

16. A shellfish harvesting apparatus as in claim 15 wherein the boom and the floating vessel connect at a first pivot point, the boom and the gathering arm connect at a second pivot point, and the gathering arm and the gathering device connect at a third pivot point.

17. A shellfish harvesting apparatus as in claim 16 further comprising a first actuator connected to the floating vessel and the boom, a second actuator connected to the boom and the gathering arm, and a third actuator connected to the gathering arm and the gathering device, the first actuator configured to move the boom relative to the floating vessel about the first pivot point, the second actuator configured to move the gathering arm relative to the boom about the second pivot point, and the third actuator configured to move the gathering device relative to the gathering arm about the third pivot point.

18. A shellfish harvesting apparatus as in claim 17 wherein at least one actuator is a piston and hydraulic cylinder arrangement.

19. A shellfish harvesting apparatus as in claim 15 wherein the floating vessel is a boat.

20. A shellfish harvesting apparatus as in claim 15 further comprising spray ports located adjacent the gathering device, the spray ports configured to spray a liquid onto the shellfish within the gathering device.
